(19) United States
(12) Patent Application Publication
(10) Pub. No.: US 2020/0118219 A1
(43) Pub. Date: Apr. 16, 2020

(54) Multi-Jurisdictional Payroll Tax Compliance System

(71) Applicant: Terah Anne Mauricio, Sarasrota, FL (US)

(72) Inventor: Terah Anne Mauricio, Sarasrota, FL (US)

(21) Appl. No.: 16/157,743

(22) Filed: Oct. 11, 2018

(51) Int. Cl. G06Q 40/00; G06Q 10/10

(52) U.S. Cl. CPC G06Q 40/123; G06Q 10/105

(57) ABSTRACT

A jurisdictional based tax assistance system provides the elapsed time an employee works in a specified tax jurisdiction. The system then compiles the elapsed time spent in each jurisdiction and calculates taxable wages by de minimis standards for each jurisdiction.

### CROSS-REFERENCE TO RELATED APPLICATION(S)

The present application claims priority to U.S. Provisional Patent Application No. 62/561,415 filed on Sep. 21, 2018, entitled “Multi-Jurisdictional Payroll Tax Compliance System” the entire disclosure of which is incorporated by reference herein.

### BACKGROUND OF THE INVENTION

### 1. Field of Invention

The present invention relates to the field of geographic location monitoring for tax compliance, including cross-referencing of reciprocal agreements and de minimis standards, as well as tax forms to prepare documents and withhold taxes as required by law.

### 2. Description of Related Art

As worker mobility and telecommuting has increased, workers may live and work in different tax jurisdictions, or they may simply work in multiple jurisdictions. Workers may work when on vacation, or while travelling between destinations. For example; a Regional Retail Manager may travel between stores in 3 states. The employee may incur liability, depending on the state laws (reciprocal agreements and de minimis standards), in each of the 3 states, and the employer is required by law to track and report the taxable wages in each state and withhold the appropriate tax from the employee's paycheck.

Taxes vary by jurisdiction, by state, locally, and federally in the United States, for example, and by country and state within that country, as in Europe, for example. There are often de minimis activities and reciprocal agreements that trigger tax-filing and withholding requirements. The law actually requires the employer to track time and work activity, report taxable wages, and withhold tax for the appropriate jurisdictions. Corporate officers can face imprisonment if the company is found to be willfully neglectful. Auditors are beginning to ask for expense reimbursement records and company travel itineraries and are using these items as proof that the company had knowledge of the employees' whereabouts and neglected their responsibilities. Auditors can also hold individuals responsible for reporting on their individual income tax return, but more commonly make the employer pay what they should have withheld from the employee. However, tax compliance by companies can be costly in terms of time and tax consultant costs, and even if employers know that they are required to file in another jurisdiction, often fail to do so as a result of the complexity of filing. Employers may not know where their employees are working from, and states or countries are missing out on tax revenue that is never received due to ignorance of the employers in the requirements for tax return filings, and underreporting as the employers do not appropriately track the details of their workers activities performed in out of state, city, or foreign jurisdictions.

There are no systemic ways to monitor the location of the user or employee, track the taxable wages, and cross-reference it all with the applicable tax laws to determine the appropriate tax distribution. With users voluntarily reporting, they are likely to underreport, as they are unfamiliar with the tax laws and employers rarely track their employees' movement appropriately. There is generally an audit trail, due to travel expenses being paid for or reimbursed by the employer, but detail is not typically provided to the payroll department, and most payroll tax departments don't understand the complexity of multi jurisdictional tax laws and have to hire tax attorneys or tax consultants to advise them. However, they need to know where the employee worked in order to take the situation to the consultant for advice on appropriate tax distribution. This has to be done for each individual that traveled, each pay period. Also, if an employee has any trailing compensation (ex. commission for the previous month), the tax distribution for that payment needs to be based on where the employee worked during the time that the payment was earned. Tax Consultants and Attorneys generally charge quite a bit and make compliance for a number of employees an expensive composition. Further, there is no centralized means that informs the user when they trigger the need for tax compliance, and which forms are needed for compliance and how to fill them out.

Based on the foregoing, there is a need in the art for an automated system that determines a user's location while a user is working, and determines which, if any, reciprocal agreements apply to the user, and determines when filing thresholds are met which trigger a requirement for filing and withholding of payroll taxes. A helpful filing assistant to determine which forms are required and assist with filling the forms would be beneficial to saving a user's time and increasing tax compliance. Finally, reports provided to the payroll tax department, furnishing the appropriate tax distribution for each traveling employee, each pay period, would be beneficial to the employer in progressing multi jurisdictional payroll tax compliance.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a screenshot view of the system, according to an embodiment of the present invention;

FIG. 2 is a further screenshot view of the system, according to an embodiment of the present invention; and

FIG. 3 is a further screenshot view of an employer dashboard of the system, according to an embodiment of the present invention;

FIG. 4 is a further screenshot view of the employer dashboard, according to an embodiment of the present invention;

FIG. 5 is a further screenshot view of a query view for form submissions, according to an embodiment of the present invention;

FIG. 6 is a flowchart view of the system, according to an embodiment of the present invention.

FIG. 7 is block diagram view of the system, according to an embodiment of the present invention.

FIG. 8 is a block diagram view of a network which may work with the system, according to an embodiment of the present invention.

FIG. 9 is a block diagram view of a network which may work with or implement various parts of the system, according to an embodiment of the present invention.

### DETAILED DESCRIPTION OF PREFERRED EMBODIMENTS

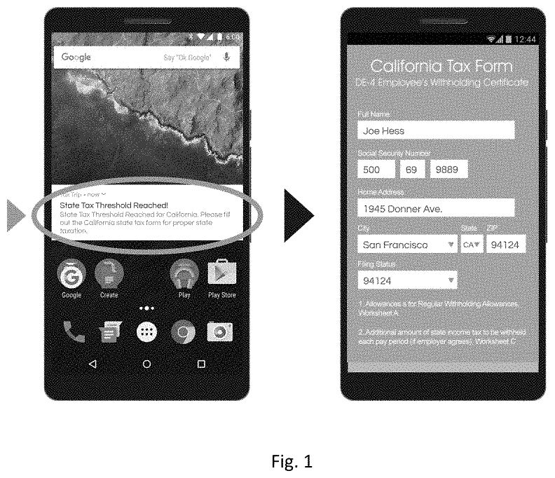

Preferred embodiments of the present invention and their advantages may be understood by referring to FIGS. 1-9, wherein like reference numerals refer to like elements.

The system monitors a user's location by GPS, cell phone tower or Wi-Fi connection location, and stores the location on the server, periodically updating the location when it changes. The location is also tied to time stamps to determine the amount of time spent in a specific location. This app is not intended as a timekeeping system. However, it does track location and each time an employee crosses into a new jurisdiction, the app will ask if they are there for work. If the employee is an exempt salary employee, there is no need to track hours worked. If they are an hourly employee they will be asked to enter the number of hours that they worked. The employer can bump it up against the hours in their time keeping system and make any necessary edits.

If there is ever a situation where the GPS or the carrier cellular tower cannot precisely determine the employees work location, the app will ask the employee to enter their address manually. The system may also use heuristics or general rules to determine jurisdiction in locations that are close.

The system monitors the location and determines if a change in location occurs, at which point the system updates the location. The location is updated and tracked regardless of whether a threshold is reached, as it may still be reportable, while it may not require withholding, and if the employee travels there again during the year, it may be added to the previous business trip, as any time spent there during the year counts towards reaching the thresholds.

The user and employer may set up a profile, which includes profile information such as name and address, and primary work location. The employee's primary work location is required because the de minimis standards are not tracked there, as it is assumed they will surpass it during the year, so wages are taxed immediately for that jurisdiction.

The system cross-references the location with state, city, or country tax codes, to determine the time and/or wage requirements working in that state, city, or country to trigger tax returns or compliance in that state, city, or country. In an embodiment, there may be both business subscriptions and individual subscriptions. The business subscription will allow employers to properly withhold employee taxes and report taxable wages to the correct jurisdictions. The individual subscription will allow individuals to see if their employer is taxing them in the appropriate jurisdictions, and bring it to the employers' attention if they are not. This app will also give employees the information they need to proactively report their taxable wages to the proper jurisdiction on their personal income tax returns. This app will give both businesses and individuals peace of mind in an audit. Please see the attached images for the information that is gathered in the profile. Businesses will start by completing the company profile, which will include the building of pre-tax deduction tables. These deduction tables will include the deduction type, frequency of deduction, and premium amounts, which create the menu that employees choose from during their profile creation. This simplifies it for employees, and to the extent possible, all they need to do is match up their deductions to the ones on their paystub. Once the company has finished filling out its profile, it may choose to fill out the employees' profiles or to send the employees a link to fill out their own profile. An individual using this app on their own would bypass the company profile and only complete the employee portion. In an embodiment, employers will need to audit employee data and bump it up against the info in their payroll software.

The server contains tax code and compliance information so as to calculate values for, and process, any applicable reciprocity agreements, de minimis standards for each state, city, or country, fill and submit state tax forms, non-resident forms, GPS work location, residency location, taxable wages, and trailing compensation to determine appropriate tax distribution for country, state and/or city, as well as where tax liabilities need to be reported and withheld. In addition, the system creates an audit trail for work location and time to substantiate tax claims, and the system may also provide information on mileage for mileage reimbursement.

The system may automate the preparation of and submit completed non-resident forms and tax forms, which are used for the employer to remain compliant with the tax laws of each jurisdiction. This information is based on applicable reciprocity agreements, de minimis standards, GPS work location, residency location, wages, pre-tax deductions, and trailing compensation to determine appropriate tax distribution for country, state and/or city, as well as where tax liabilities need to be reported and withheld.

In an embodiment, when a threshold of presence in another state is passed, the user is alerted of meeting a jurisdictional tax threshold, and when applicable, is then being taken to a second screen containing information required for tax compliance of the other jurisdiction, which may be filled out within the system and submitted by the system. Non-resident forms will also be delivered to the employee in the same electronic manner. With reference to FIG. 1, the user's time spent within the jurisdiction goes over the threshold, it triggers the system to provide the form. The system maintains a user profile, and the tax form is prepopulated with the profile information for ease of form completion and submission.

Once the jurisdictional tax form has been filled out and submitted, the system notifies the employer via email or another standard reporting mechanism. The employer can also login to the system website, or through a mobile app, can see any tax forms that have been filled out and submitted by the user or employee. The user or employer will also have the ability to print out historical submitted tax forms from the system, for later reference or for audit purposes.

This process streamlines and automates which state and city tax forms are completed by users and employees and submitted to their employer and/or tax authorities. Completed state tax form may be submitted from mobile device to employer for proper employee taxation.

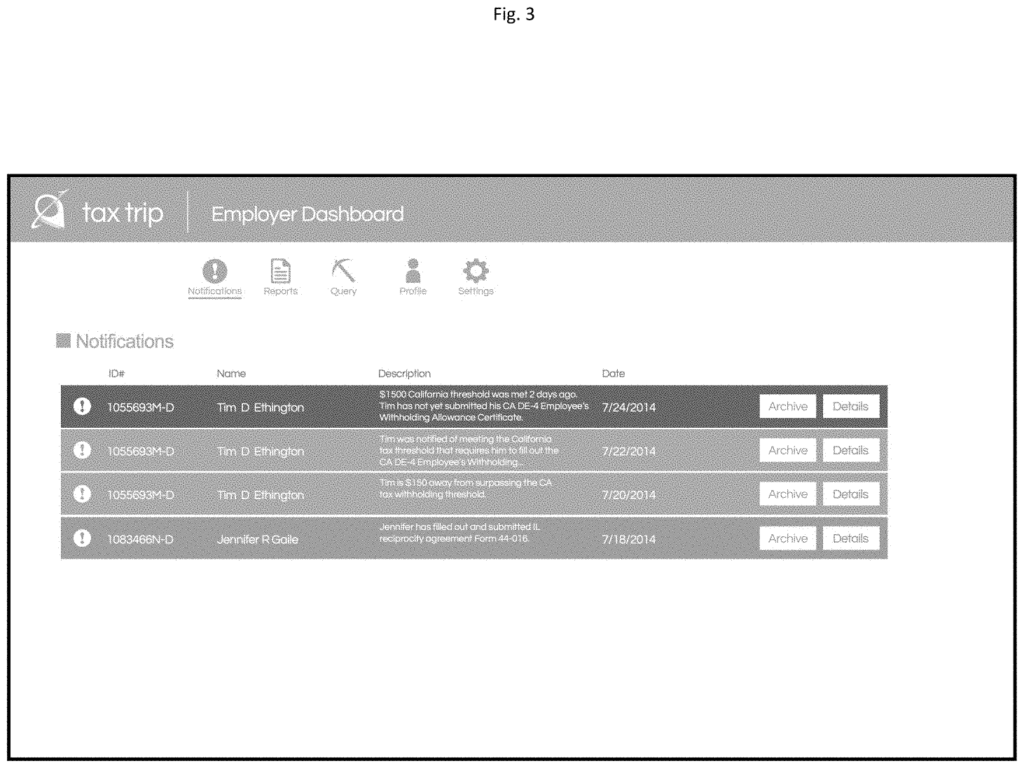

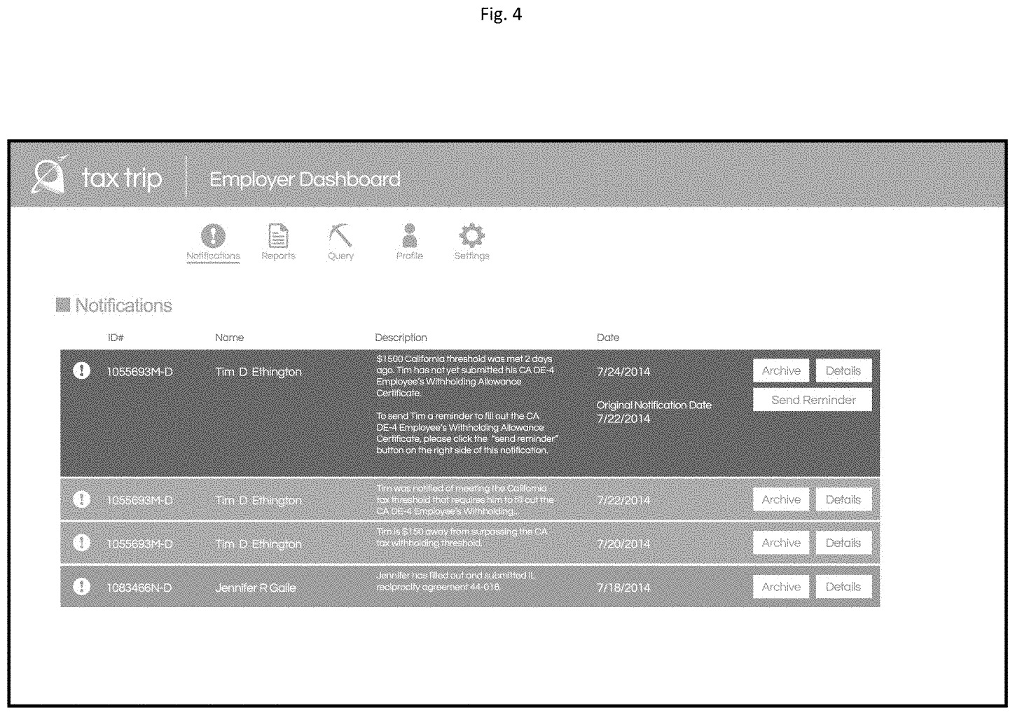

The user and their employer will be able to access custom Employee Tax Distribution Reports from the Tax Trip mobile app and/or the Tax Trip website in the form of but not limited to) a spreadsheet, PDF, and HTML document. With reference to FIGS. 3 and 4, the Employer Dashboard is shown. For each employee, in this case “Tim Ethington”, the events or notifications are listed. Tim met his CA threshold 2 days ago but did not submit the form yet. Earlier there were notifications that he was nearing his threshold. Once the threshold is met, the system reminds the employee periodically to fill the form and maintains deadlines for form submission. In FIG. 4, the employer may send reminders and archive or delete the notifications.

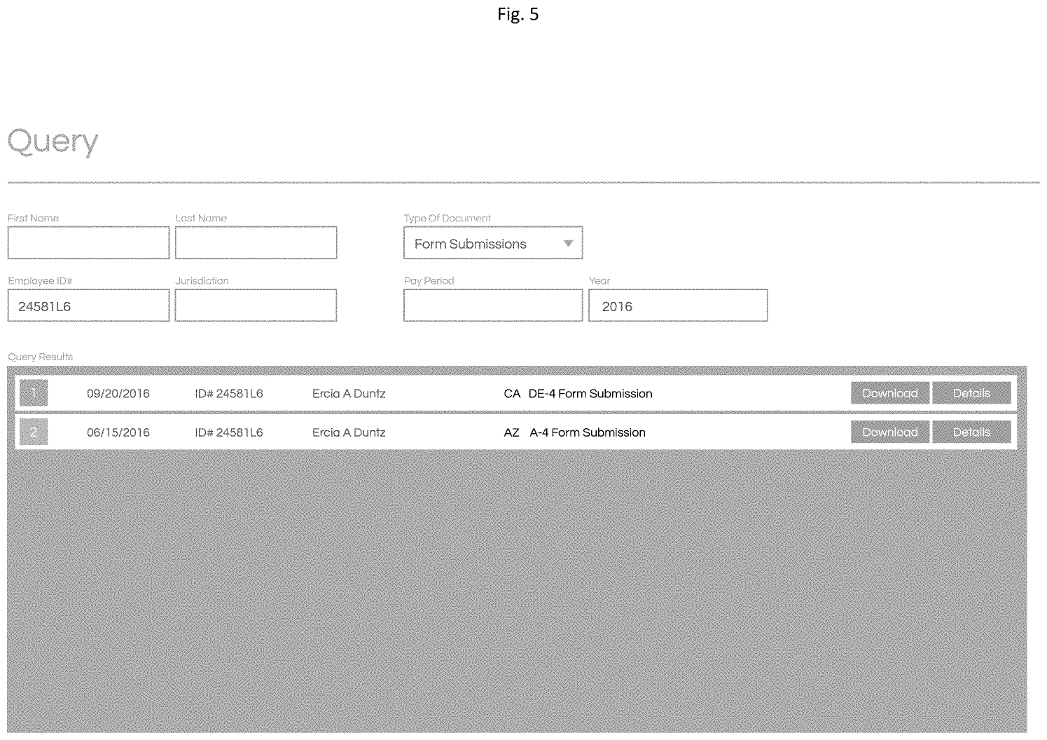

With reference to FIG. 5, the employer may query form submissions and receive copies of forms that are submitted, along with submission dates and confirmations.

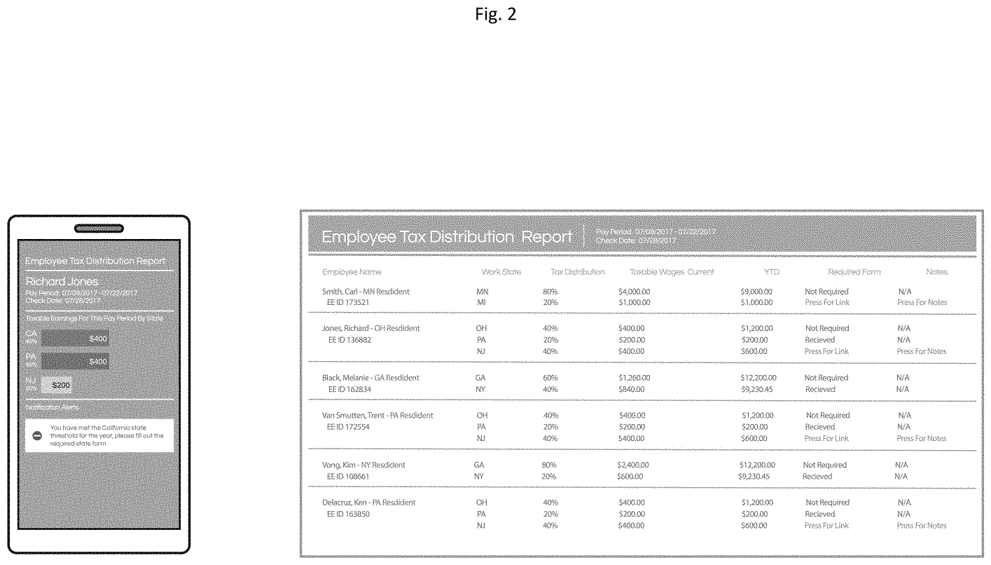

The user and their employer will be able to access custom Employee Tax Distribution Reports from the Tax Trip mobile app and/or the Tax Trip website in the form of but not limited to) a spreadsheet, PDF, and HTML document. With reference to FIG. 2, an example screen shot of the employee tax distribution report for the employer is shown. Each record shows an individual employed by the company, with residency and the work states shown, as well as a taxable distribution which results in a corresponding breakdown in the taxable wages. A required form is provided for each state, if required, according to the knowledge of tax processes of the system.

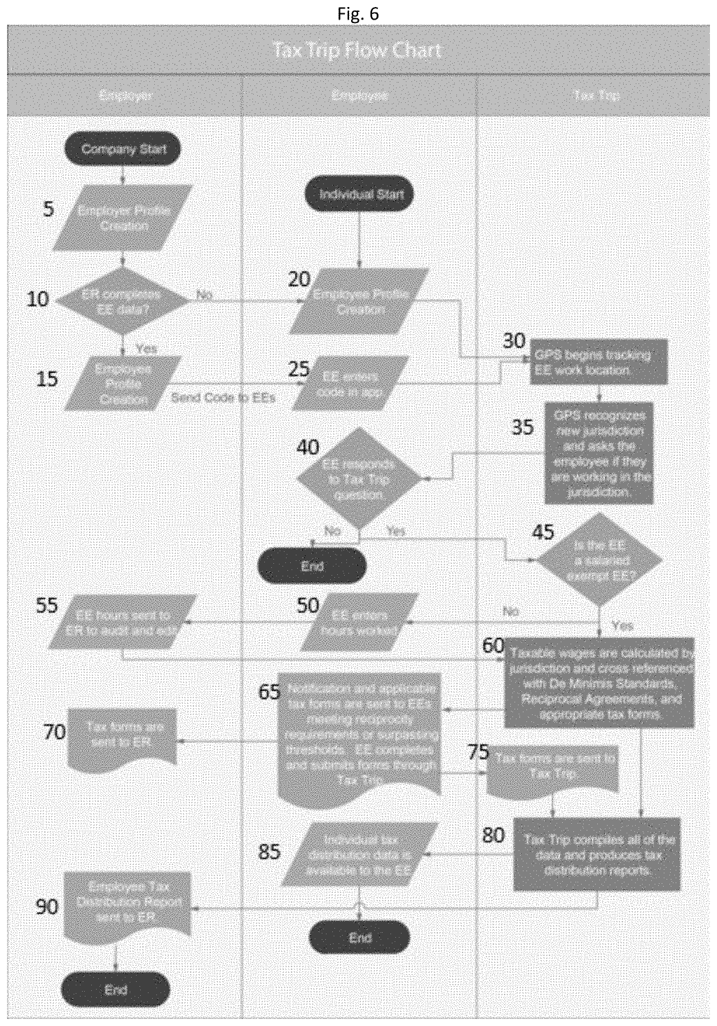

With reference to FIG. 6, a flow chart of the system is shown. From the employer side, the employer creates a profile in step 5, and in step 10 if the employer can complete the employee data, then he or she does so at step 15, otherwise the employee is invited to create a profile at step 20. Where the employer fills the information in step 15, the completed form is sent to the employee for verification and confirmation at step 25. In either case, whether the profile is employer or employee filled, the information is sent to the system at step 30 and the GPS begins tracking the employees work location and reporting same to the system, wherein the system may comprise one or more computers/servers in the cloud.

As the GPS is monitoring the employee's location, the GPS recognizes new jurisdictions and asks the employee if they are working in the jurisdiction in step 35. The employee then responds to the system's confirmation at step 40. If the employee confirms that he or she is not working, then the procedure terminates. However, if the employee confirms that he or she is working in the jurisdiction, then the system determines if the employee is a salaried exempt employee at step 45. If no, the employee enters the hours worked in step 50, and the employee hours are sent to the employer to audit and edit at step 55. If yes at step 45, or after the employee hours are sent to the employer at step 55, then the taxable wages are calculated by jurisdiction and cross-referenced using de minimis standards, reciprocal agreements and appropriate tax forms in step 60.

In step 65 notification and applicable tax forms are sent to employees meeting reciprocity requirements or surpassing thresholds. The employees complete and submit forms through the system, and the tax forms are also sent to the employer at step 70 and recorded in the system at step 75. In step 80, the system compiles all of the data and produces tax distribution reports. In step 85, individual tax distribution data is available to the employee. In step 90, the employee tax distribution report is sent to the employer, and displayed on the employer dashboard.

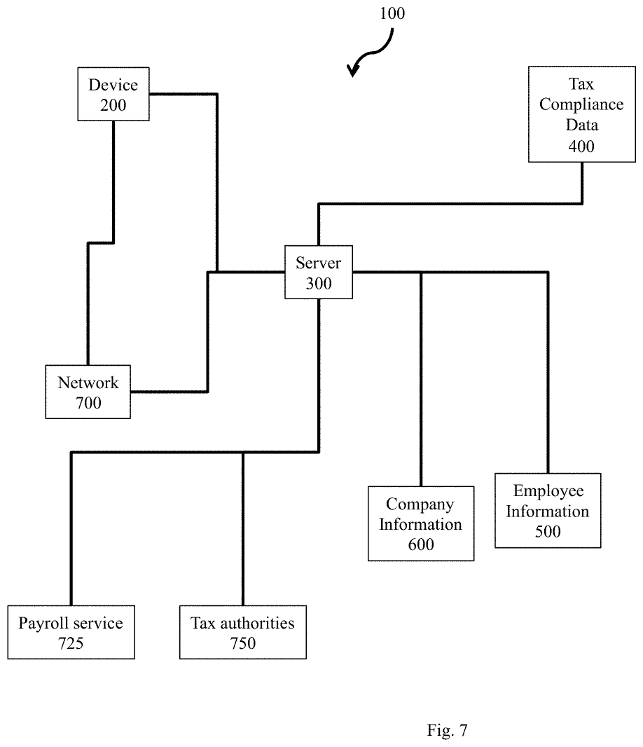

FIG. 7 illustrates a system which may be used to implement the process of FIG. 6 and other processes associated with other embodiments, for example. System 100 includes a server 300 and a device 200, which may be coupled to each other directly or through a network 700. Server 300 may also draw on information from tax compliance data 400, employee data 500 and company data 600, all of which may accessible directly, such as through storage of the server, or through a network such as network 700, for example. Company data 600 may be specific data for a company and employee data 500 may be specific data for employees of a company, including eligibility and restriction information, for example, or policy information, along with data such as locations of work sites, for example. Tax compliance data 400 may include data about specific tax compliance requirements, including thresholds, evaluation factors, requirements, guidelines, regulatory requirements, and other data, for example. Tax compliance data 400 may include data for a number of different states or provinces along with federal or overall data, for example.

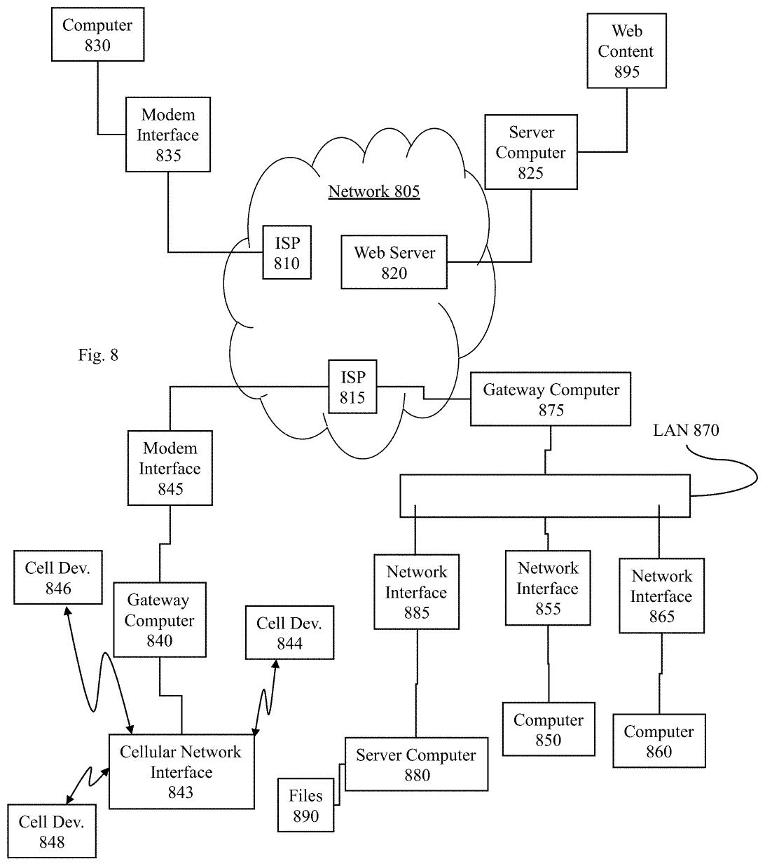

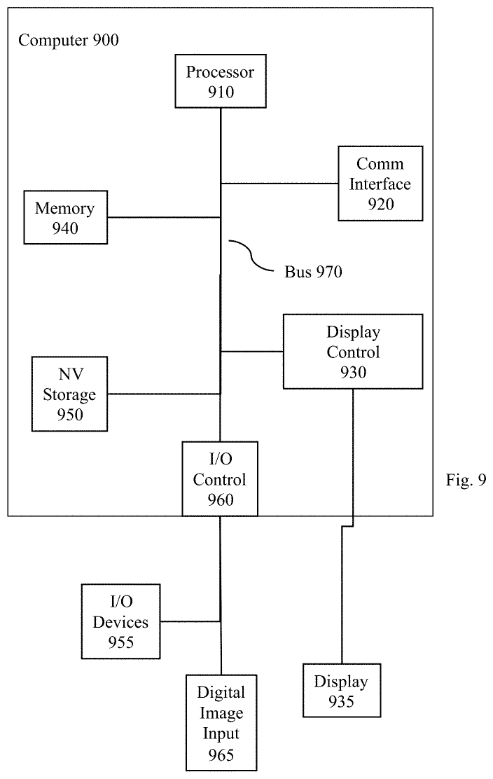

Server 300 may receive GPS data and other measured data from device 200, tracking physical movement of an employee, and may catalog that data with information associated with tax compliance requirements. Server 300 may then provide data for tax compliance purposes to a company for review, or may automatically report such data to tax authorities 750, payroll systems 725, or other systems as well. Moreover, server 300 may implement all of these functions in a parallel or serial manner. Reporting and review may occur through interfaces with network 700, for example, or through some form of direct connection. Additionally, server 300 may be implanted virtually, such as through a system and network along the lines of that shown in FIGS. 8 and 9, herein.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device (“PLD”) such as a Field-Programmable Gate Array (“FPGA”), Programmable Logic Array (“PLA”), or Programmable Array Logic (“PAL”), or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ 8 operating system, Microsoft Windows™ 7 operating system, the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, an Open Source operating system or other operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

The display as used herein is contemplated as a light emitting diode (LED) display, liquid crystal display (LCD), microelectromechanical systems (MEMS) display or any display suitable for use with a computer of mobile computing device.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

The following description of FIGS. 8-9 is intended to provide an overview of device hardware and other operating components suitable for performing the methods of the invention described above and hereafter, but is not intended to limit the applicable environments. The device hardware of FIGS. 8 and 9 may implement a processing system as referred to above, and may include other parts of a network and related devices or systems used to effectuate various parts of the invention in various embodiments. The hardware and other operating components may be suitable as part of the apparatuses described above. The invention can be practiced with other system configurations, including personal computers, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 8 shows several computer systems that are coupled together through a network 805, such as the internet, along with a cellular or other wireless network and related cellular or other wireless devices. The term “internet” as used herein refers to a network of networks which uses certain protocols, such as the TCP/IP protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 805 is typically provided by internet service providers (ISP), such as the ISPs 810 and 815. Users on client systems, such as client computer systems 830, 850, and 860 obtain access to the internet through the internet service providers, such as ISPs 810 and 815. Access to the internet allows users of the client computer systems to exchange information, receive and send e-mails, and view documents, such as documents which have been prepared in the HTML format. These documents are often provided by web servers, such as web server 820 which is considered to be “on” the internet. Often these web servers are provided by the ISPs, such as ISP 810, although a computer system can be set up and connected to the internet without that system also being an ISP.

The web server 820 is typically at least one computer system which operates as a server computer system and is configured to operate with the protocols of the world wide web and is coupled to the internet. Optionally, the web server 820 can be part of an ISP which provides access to the internet for client systems. The web server 820 is shown coupled to the server computer system 825 which itself is coupled to web content 895, which can be considered a form of a media database. While two computer systems 820 and 825 are shown in FIG. 8, the web server system 820 and the server computer system 825 can be one computer system having different software components providing the web server functionality and the server functionality provided by the server computer system 825 which will be described further below.

Cellular network interface 843 provides an interface between a cellular network and corresponding cellular devices 844, 846 and 848 on one side, and network 805 on the other side. Thus cellular devices 844, 846 and 848, which may be personal devices including cellular telephones, two-way pagers, personal digital assistants or other similar devices, may connect with network 805 and exchange information such as email, content, or HTTP-formatted data, for example.

Cellular network interface 843 is representative of wireless networking in general. In various embodiments, such an interface may also be implemented as a wireless interface such as a Bluetooth interface, IEEE 802.11 interface, or some other form of wireless network. Similarly, devices such as devices 844, 846 and 848 may be implemented to communicate via the Bluetooth or 802.11 protocols, for example. Other dedicated wireless networks may also be implemented in a similar fashion.

Cellular network interface 843 is coupled to computer 840, which communicates with network 805 through modem interface 845. Computer 840 may be a personal computer, server computer or the like, and serves as a gateway. Thus, computer 840 may be similar to client computers 850 and 860 or to gateway computer 875, for example. Software or content may then be uploaded or downloaded through the connection provided by interface 843, computer 840 and modem 845.

Client computer systems 830, 850, and 860 can each, with the appropriate web browsing software, view HTML pages provided by the web server 820. The ISP 810 provides internet connectivity to the client computer system 830 through the modem interface 835 which can be considered part of the client computer system 830. The client computer system can be a personal computer system, a network computer, a web tv system, or other such computer system.

Similarly, the ISP 815 provides internet connectivity for client systems 850 and 860, although as shown in FIG. 8, the connections are not the same as for more directly connected computer systems. Client computer systems 850 and 860 are part of a LAN coupled through a gateway computer 875. While FIG. 8 shows the interfaces 835 and 845 as generically as a “modem,” each of these interfaces can be an analog modem, isdn modem, cable modem, satellite transmission interface (e.g. “direct PC”), or other interfaces for coupling a computer system to other computer systems.

Client computer systems 850 and 860 are coupled to a LAN 870 through network interfaces 855 and 865, which can be ethernet network or other network interfaces. The LAN 870 is also coupled to a gateway computer system 875 which can provide firewall and other internet related services for the local area network. This gateway computer system 875 is coupled to the ISP 815 to provide internet connectivity to the client computer systems 850 and 860. The gateway computer system 875 can be a conventional server computer system. Also, the web server system 820 can be a conventional server computer system.

Alternatively, a server computer system 880 can be directly coupled to the LAN 870 through a network interface 885 to provide files 890 and other services to the clients 850, 860, without the need to connect to the internet through the gateway system 875.

FIG. 9 shows one example of a personal device that can be used as a cellular telephone (844, 846 or 848) or similar personal device, or may be used as a more conventional personal computer, as an embedded processor or local console, or as a PDA, for example. Such a device can be used to perform many functions depending on implementation, such as monitoring functions, user interface functions, telephone communications, two-way pager communications, personal organizing, or similar functions. The system 900 of FIG. 9 may also be used to implement other devices such as a personal computer, network computer, or other similar systems. The computer system 900 interfaces to external systems through the communications interface 920. In a cellular telephone, this interface is typically a radio interface for communication with a cellular network, and may also include some form of cabled interface for use with an immediately available personal computer. In a two-way pager, the communications interface 920 is typically a radio interface for communication with a data transmission network, but may similarly include a cabled or cradled interface as well. In a personal digital assistant, communications interface 920 typically includes a cradled or cabled interface, and may also include some form of radio interface such as a Bluetooth or 802.11 interface, or a cellular radio interface for example.

The computer system 900 includes a processor 910, which can be a conventional microprocessor such as an Intel pentium-based microprocessor or other microprocessor, a Texas Instruments digital signal processor, or some combination of the various types or processors. Memory 940 is coupled to the processor 910 by a bus 970. Memory 940 can be dynamic random access memory (dram) and can also include static ram (sram), or may include FLASH EEPROM, too. The bus 970 couples the processor 910 to the memory 940, also to non-volatile storage 950, to display controller 930, and to the input/output (I/O) controller 960. Note that the display controller 930 and I/O controller 960 may be integrated together, and the display may also provide input.

The display controller 930 controls in the conventional manner a display on a display device 935 which typically is a liquid crystal display (LCD) or similar flat-panel, small form factor display. The input/output devices 955 can include a keyboard, or stylus and touch-screen, and may sometimes be extended to include disk drives, printers, a scanner, and other input and output devices, including a mouse or other pointing device. The display controller 930 and the I/O controller 960 can be implemented with conventional well known technology. A digital image input device 965 can be a digital camera which is coupled to an I/O controller 960 in order to allow images from the digital camera to be input into the device 900.

The non-volatile storage 950 is often a FLASH memory or read-only memory, or some combination of the two. A magnetic hard disk, an optical disk, or another form of storage for large amounts of data may also be used in some embodiments, though the form factors for such devices typically preclude installation as a permanent component of the device 900. Rather, a mass storage device on another computer is typically used in conjunction with the more limited storage of the device 900. Some of this data is often written, by a direct memory access process, into memory 940 during execution of software in the device 900. One of skill in the art will immediately recognize that the terms “machine-readable medium” or “computer-readable medium” includes any type of storage device that is accessible by the processor 910 and also encompasses a carrier wave that encodes a data signal. Alternatively, a physical medium may be used as a machine-readable medium or computer-readable medium.

The device 900 is one example of many possible devices which have different architectures. For example, devices based on an Intel microprocessor often have multiple buses, one of which can be an input/output (I/O) bus for the peripherals and one that directly connects the processor 910 and the memory 940 (often referred to as a memory bus). The buses are connected together through bridge components that perform any necessary translation due to differing bus protocols.

In addition, the device 900 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of an operating system software with its associated file management system software is the Apple OS® operating system and its associated file management system. The file management system is typically stored in the non-volatile storage 950 and causes the processor 910 to execute the various acts required by the operating system to input and output data and to store data in memory, including storing files on the non-volatile storage 950. Other operating systems may be provided by makers of devices, and those operating systems typically will have device-specific features which are not part of similar operating systems on similar devices. Similarly, WinCEÆ or PalmÆ operating systems may be adapted to specific devices for specific device capabilities.

Device 900 may be integrated onto a single chip or set of chips in some embodiments, and typically is fitted into a small form factor for use as a personal device. Thus, it is not uncommon for a processor, bus, onboard memory, and display/I-O controllers to all be integrated onto a single chip. Alternatively, functions may be split into several chips with point-to-point interconnection, causing the bus to be logically apparent but not physically obvious from inspection of either the actual device or related schematics.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed.

1. A system for managing tax jurisdiction data for one or more employees of a company, wherein the tax jurisdiction data includes an elapsed time spent in one or more tax jurisdictions, the system comprising:
an employee device having a location data sensor and a network interface;
a server in communication with the employee device having a data storage module associated therewith, the data storage module to receive location data of the employee device through a network interface of the server, the server further having access to reference tax code information, the server further having access to encoding information for tax compliance, the server further in communication with tax authorities for transmission of tax compliance information associated with an employee of the employee device, the server further in communication with the company for review and interaction with location data of the employee device.

2. The system of claim 1, wherein:
the employee device collects location information of the employee using the location data sensor and collects timing information as part of the location information.

3. The system of claim 2, wherein:
the location information includes time and location information associated with non-work activities of the employee; and the employee device filters out of location information time and location information associated with non-work activities of the employee.

4. The system of claim 2, wherein:
the location information includes time and location information associated with non-work activities of the employee; and the server filters out of location information time and location information associated with non-work activities of the employee.

5. The system of claim 2, wherein:
the location information of the employee includes hours worked by the employee in a first physical location and hours worked by the employee in a second physical location.

6. The system of claim 5, wherein:
the first physical location is in a first jurisdiction and the second physical location is in a second jurisdiction.

7. The system of claim 6, wherein:
the location information includes time and location information associated with travel between the first physical location and the second physical location.

8. The system of claim 7, wherein:
the server filters out location information of the employee which falls below de minimis reporting requirements.

9. (canceled)

10. (canceled)

11. A system for managing tax jurisdiction data for one or more employees, wherein the tax jurisdiction data includes an elapsed time spent in one or more tax jurisdictions, the system comprising:
an employee device having a means to provide location data;
a server in communication with the employee device having a means for storing the location data of the employee device, the server further having means to reference tax code information.

12. A process for managing tax jurisdiction data for one or more employees of a company, wherein the tax jurisdiction data includes an elapsed time spent in one or more tax jurisdictions, the method comprising:
sensing location information of an employee with a data sensor of an employee device;
transmitting the location information of the employee from the employee device through a network interface to a server;
receiving at the server through a network interface of the server the location information of the employee;
storing the location information of the employee in a data storage module of the server;
comparing at the server the location information of the employee to tax requirements of jurisdictions associated with the employee;
presenting location information of the employee to the company in the form of a user;
receiving feedback from the user related to the location information of the employee;
encoding at the server the location information of the employee for tax compliance;
and
transmitting from the server to tax authorities the location information of the employee as encoded.

13. The process of claim 12, wherein:
the location information of the employee includes hours worked by the employee in a first physical location and hours worked by the employee in a second physical location.

14. The process of claim 13, wherein:
the first physical location is in a first jurisdiction and the second physical location is in a second jurisdiction.

15. The process of claim 14, wherein:
the location information includes time and location information associated with travel between the first physical location and the second physical location.

16. The process of claim 15, wherein:
the location information includes time and location information associated with non-work activities of the employee
and further comprising:
filtering out of location information time and location information associated with non-work activities of the employee.

17. The process of claim 11, further comprising:
filtering out location information of the employee which falls below de minimis reporting requirements.
